(19) United States
(12) Patent Application Publication
(10) Pub. No.: US 2012/0038197 A1
(43) Pub. Date: Feb. 16, 2012

(54) LEG SUPPORT INSERT FOR SEATING APPARATUS

(75) Inventors: William R. Beland, Grand Haven, MI (US); Scott Hayes, Holland, MI (US); Toby Keith Jacobson, West Olive, MI (US); Benjamin T. Fredricks, Grand Haven, MI (US)

(73) Assignee: SHAPE CORPORATION, Grand Haven, MI (US)

(21) Appl. No.: 13/210,085

(22) Filed: Aug. 15, 2011

Related U.S. Application Data
(60) Provisional application No. 61/373,948, filed on Aug. 16, 2010.

(51) Int. Cl. A47C 16/02; B23P 11/02; B23P 17/04

(52) U.S. Cl. 297/423.4; 29/428; 29/453

(57) ABSTRACT

A chair construction is provided including seat inserts that attach to the lower surface of a seat body and are capable of receiving the leg support structure. In one embodiment, the chair includes four plastic seat inserts molded to the lower surface of a plastic seat body. The inserts each include a notch that is sized to receive a portion of the leg support structure, such as a cross member. The cross member can be snap fit into the notch and attach to the insert without attaching directly to the seat body. Fasteners may be used to secure the cross member to the insert.

### BACKGROUND OF THE INVENTION

The present invention relates to seating applications, and more particularly to a structure and method for attaching a leg support structure to a seat body in an institutional seating application.

Institutional chairs are well known for use in a variety of applications in which it is desired to have multiple, and often very many, chairs that are durable and easy to arrange in a variety of configurations. For instance, institutional chairs are commonly arranged in rows and used in classroom and office applications.

A typical institutional chair includes a seat body portion that includes a generally horizontal seat portion and a generally vertical seat back portion extending upwardly from the seat portion. The seat body portion may be formed from a variety of materials, such as molded plastic, fiberglass or metal, and is often with a curved shape to provide a degree of comfort to a user sitting in the chair. The seat body portion is supported above the ground at a desired height by a leg support structure, which is generally formed from metal and includes legs that are connected together at their upper ends by one or more cross pieces.

Problems often arise in the attachment of the leg support structure to the seat body. Many institutional chairs include self tapping screw holes formed in the lower surface of the plastic seat portion, such that fasteners can extend through the leg support structure directly into the plastic seat body. Attachment by this method is relatively easy, but in many cases the threaded screw bosses—which require thicker areas of plastic material on the seat body—show through on the upper surface of the seat body, creating unsightly sink marks on the visible portions of the seat surface. One attempt to overcome this problem is to attach one or more separate plastic pieces to the lower surface of the seat body. The plastic pieces can be attached without creating sink marks on the upper surface of the seat. In one known construction, a steel plate is attached to the plastic pieces and the leg support structure is attached to the steel plate, either by fasteners or by welding the leg support structure to the steel plate. This construction generally overcomes the problem of sink marks, but the additional steel plate adds unwanted cost, manufacturing time and weight to the chair.

### SUMMARY OF THE INVENTION

The present invention provides a chair construction including seat inserts that attach to the lower surface of a seat body and are capable of receiving the leg support structure without a separate metal plate.

In one embodiment, the chair includes four plastic seat inserts molded to the lower surface of a plastic seat body. The inserts each include a notch that is sized to receive a portion of the leg support structure, such as a cross member. The cross member can fit into the notch and attach to the insert without attaching directly to the seat body.

In a more particular embodiment, the seat inserts each include a cone shaped sidewall with an upper portion that is molded into a similarly shaped receptacle on the lower surface of the seat body. The inserts may each include a fastener hole that extends through a lower wall of the insert and into an upper wall of the notch without extending completely through the upper wall of the insert. The inserts may be spaced apart on the lower surface of the seat body such that a first leg support cross member can be inserted into the notches of two of the inserts and a second leg support cross member can be inserted into the notches of the other two inserts. The cross members may include holes aligned with the holes in the inserts to enable insertion of fasteners through the inserts and the cross member. In one embodiment, the notches may include a curved cross section that is shaped to correspond to the tubular shape of the leg support cross members. The notches may additionally include a mouth that is slightly narrower than the central portion of the notch to prevent the leg support cross member from pulling out of the notch after it has been inserted.

The attachment of inserts to the lower surface of the seat body enables the use of thinner materials within the seat body, reducing the potential for sink marks in the upper surface of the seat body. At the same time, the notches in the inserts can eliminate the need for a plate or similar structure for attaching a leg support structure to the seat body. These and other objects, advantages, and features of the invention will be more fully understood and appreciated by reference to the description of the current embodiment and the drawings.

Before the embodiments of the invention are explained in detail, it is to be understood that the invention is not limited to the details of operation or to the details of construction and the arrangement of the components set forth in the following description or illustrated in the drawings. The invention may be implemented in various other embodiments and of being practiced or being carried out in alternative ways not expressly disclosed herein. Also, it is to be understood that the phraseology and terminology used herein are for the purpose of description and should not be regarded as limiting. The use of “including” and “comprising” and variations thereof is meant to encompass the items listed thereafter and equivalents thereof as well as additional items and equivalents thereof. Further, enumeration may be used in the description of various embodiments. Unless otherwise expressly stated, the use of enumeration should not be construed as limiting the invention to any specific order or number of components. Nor should the use of enumeration be construed as excluding from the scope of the invention any additional steps or components that might be combined with or into the enumerated steps or components.

### BRIEF DESCRIPTION OF THE DRAWINGS

FIG. 1 is a bottom perspective view of a chair including seat inserts according to one embodiment of the present invention.

FIG. 2 is an exploded view of a chair including seat inserts according to one embodiment.

FIG. 3 is a cross sectional view of a portion of a seat surface, a seat insert and a portion of a chair leg.

FIG. 4 is a bottom perspective view of a chair including seat inserts according to a second embodiment of the present invention.

FIG. 5 is an exploded view of a chair including seat inserts according to the second embodiment.

FIG. 6 is a bottom perspective view of a chair including seat inserts according to a third embodiment of the present invention.

FIG. 7 is a cross sectional view taken along the line 7-7 in FIG. 6.

FIG. 8 is a cross sectional view taken along the line 8-8 in FIG. 6.

### DESCRIPTION OF THE CURRENT EMBODIMENT

I. Overview

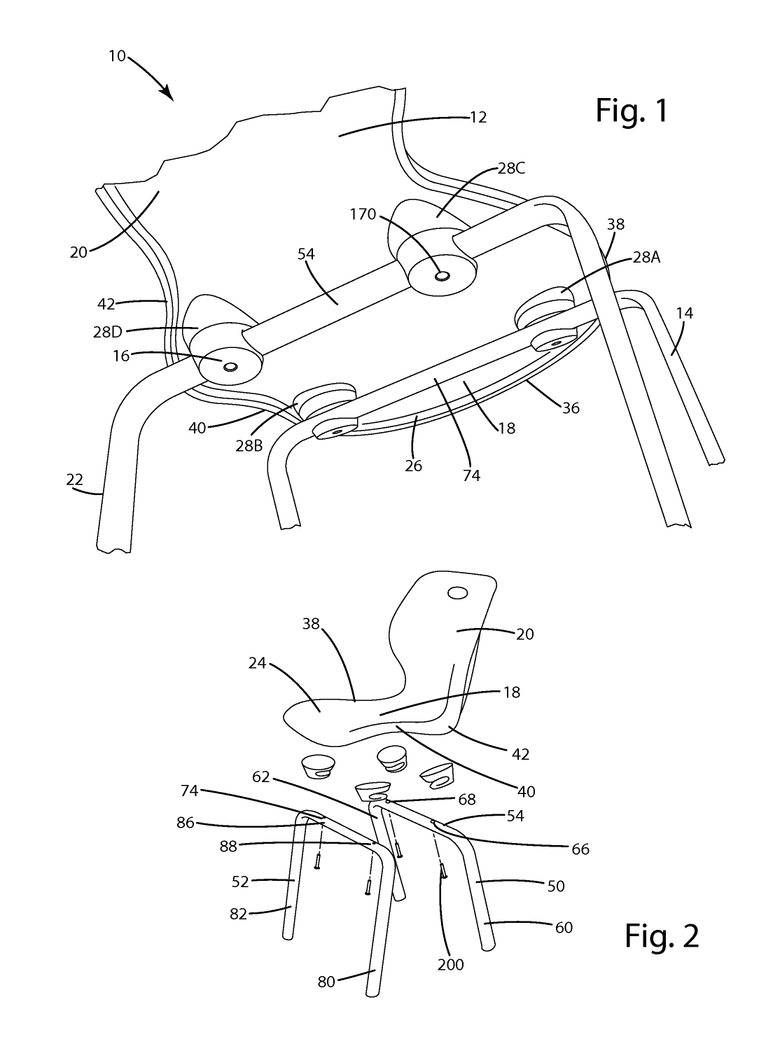

A chair according to one embodiment of the present invention is shown in FIGS. 1-3 and generally designated 10. The chair 10 generally includes a seat body 12, a leg structure 14 and one or more seat inserts 16. The seat body 12 includes a seat portion 18 and a seat back portion 20 and forms the portion of the seat that contacts the user. The leg structure 14 includes legs 22 that extend downwardly from the seat body 12 to engage the floor and to support the seat body 12 at a desired distance above the floor. The seat inserts 16 attach the seat body 12 to the leg structure 16.

II. Structure

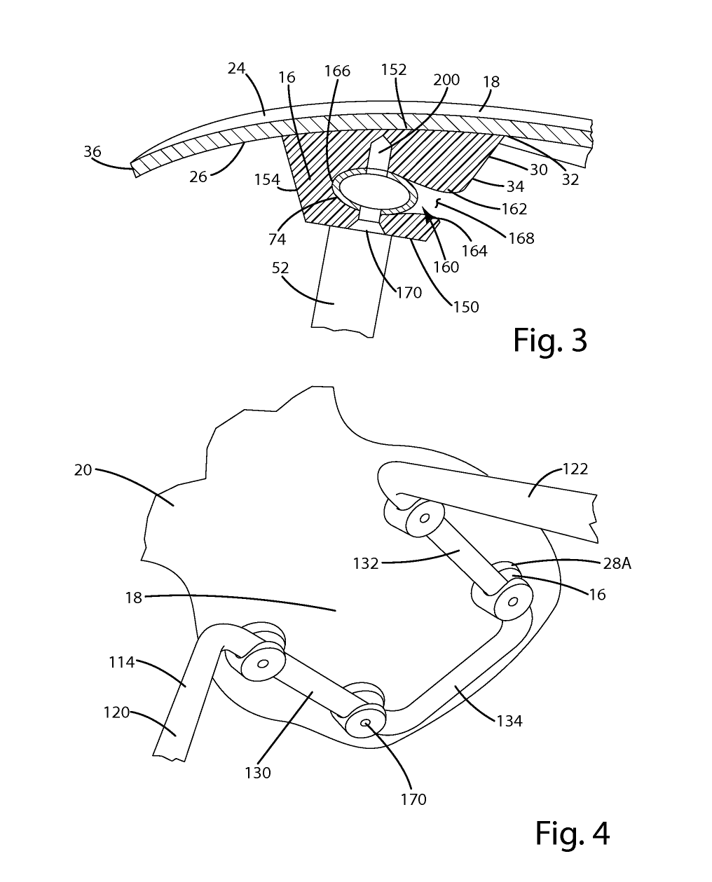

The seat body 12 may be formed form a variety of materials, and in one embodiment the seat body 12 is formed from a single piece of molded plastic, such as injection molded polypropylene. In another embodiment, the seat body 12 may be formed form multiple pieces of the same or different materials that are fastened together by conventional methods. As shown in FIGS. 1 and 2, the seat body 12 may include a seat portion 18 and a seat back portion 20. The seat portion 18 may include an upper surface 24 for engaging the user and a lower surface 26 opposite the upper surface 24. The upper surface 24 is generally horizontal, but may be contoured to provide a comfortable seating surface for a user. As shown in FIGS. 1 and 3, the lower surface 26 extends generally horizontally but is contoured to match the shape of the upper surface, and may be configured to attach to the seat inserts 16. In one embodiment, the seat portion 18 includes a front edge 36, first and second side edges 38, 40, and a rear edge 42. The seat back portion 20 may extend upwardly from the rear edge 42, and may be contoured to comfortably support the back of a user.

In the illustrated embodiment, the lower surface includes four receptacles 28a-d for attaching to the seat inserts 16. The receptacles 28a-d may be formed integrally with the seat body 12. For example, they receptacles 28a-d may be injection molded with the seat body 12 or the seat portion 18 as a single piece. As illustrated, each receptacle 28a-d includes a generally circular sidewall 30 that extends outwardly from the lower surface 26 of the seat portion 18 from a base 32 to a distal edge 34. The sidewall 30 may angle inwardly from the base 32 to the distal edge 34, such that each receptacle has a generally frustoconical shape. In an alternative embodiment, the receptacles may have a different shape, or they may be formed from a different material than the seat portion 18 and attached to the seat portion 18. The receptacles 28a-d may be spaced apart on the lower surface 26 of the seat portion 18, such that a first receptacle 28a is located proximate to the corner between the front edge 36 and the first side edge 38, the second receptacle 28b is located proximate to the corner between the front edge 36 and the second side edge 40, the third receptacle 28c is located proximate to the corner between the rear edge 42 and the first side edge 38 and the fourth receptacle 28d is located proximate to the corner between the rear edge 42 and the second side edge 40. Alternatively, the positioning of the receptacles or other attachment structure may vary from application to application.

The leg structure 14 supports the seat body 12 at a desired height above the ground. In one embodiment, the leg structure 14 is formed from steel or another metal; however, the leg structure 14 may be formed from a variety of materials with sufficient strength to support the seat body 12 and the weight of a user sitting on the seat body 12. A variety of leg configurations are known and may be utilized for supporting the seat body 12, depending on the desired application. One leg structure configuration is shown in FIGS. 1-3. In this embodiment, the leg structure 14 includes a first support member 50 and a second support member 52. The support member 50 includes a horizontal cross piece 54. A first leg 60 extends downwardly from the first end and a second leg 62 extends downwardly from the second end. The cross piece 54 may define a pair of holes 66, 68 that extend through the cross piece 54 and are spaced apart at approximately the same distance as the receptacles 28c and 28d. The support member 52 includes a horizontal cross piece 74. A first leg 80 extends downwardly from the first end and a second leg 82 extends downwardly from the second end. The cross piece 74 may define a pair of holes 86, 88 that extend through the cross piece 74 and are spaced apart at approximately the same distance as the first 28a and second 28b receptacles. As shown in FIG. 3, the support members 50, 52 may be tubular, and may have an oval shaped cross-section, although other cross-sectional shapes may be used.

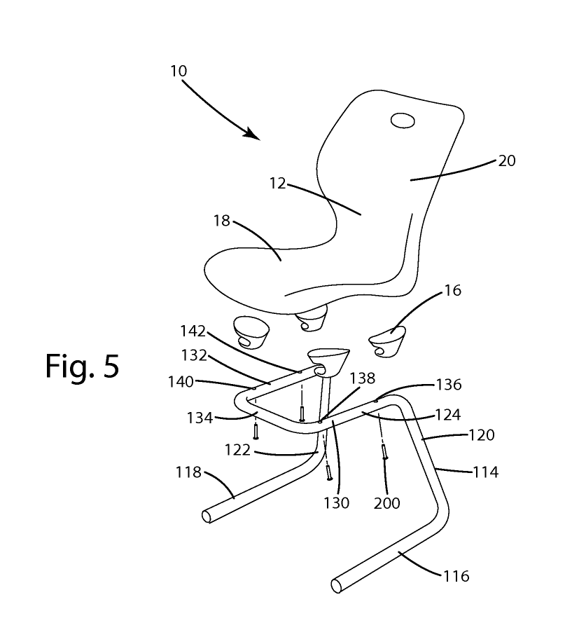

A second leg structure configuration 114 is shown in FIGS. 4 and 5. In this embodiment, the leg structure 114 is a cantilever design, including a pair of generally horizontal ground supports 116, 118, a pair of legs 120, 122 extending upwardly from the ground supports 116, 118, and a generally U-shaped support member 124 extending from the legs 120, 122. The U-shaped support member 124 may include side members 130, 132 that are spaced apart at approximately the same distance as the first 28a and second 28b receptacles and a front member 134 extending between the side members 130, 132 opposite the legs 120, 122. The first side member 130 may define a pair of holes 136, 138 that extend through the side member 130 and are spaced apart approximately the distance between the receptacles 28b and 28d. The second side member 132 may define a pair of holes 140, 142 that extend through the side member 132 and are spaced apart approximately the distance between the receptacles 28a and 28c.

The seat inserts 16 attach between the seat body 12 and the leg structure 14. The inserts may be formed from a variety of materials, such as plastic or metal. In one embodiment, the inserts are formed from injection molded nylon; however, other plastics may be used. In another embodiment, the inserts 16 are cast metal pieces. In one embodiment, the chair 10 includes four seat inserts 16, with each seat insert 16 including a circular bottom wall 150, a generally circular top wall 152, and a sidewall 154 extending between the top wall 150 and bottom wall 152. As illustrated, the inserts 16 are generally frustoconical in shape with the sidewall 154 angling inwardly as it extends from the top wall 152 towards the bottom wall 150. The angle of the sidewall 154 may match the angle of the sidewall 30 of the receptacles 28a-d to enable the sidewall 154 of each insert to engage the sidewall 30 of its respective receptacle 28a-d to retain the insert 16 within the sidewall 30 of the receptacle 28a-d. In one embodiment, each insert includes a notch 160 extending into the sidewall 154 between the bottom wall 150 and the top wall 152 for receiving a portion of the leg structure 14. In the illustrated embodiment, the notch 160 extends into the sidewall 154 a distance approximately equal to ¾ of the diameter of the insert 16. The notch 16 includes an upper wall 162, a lower wall 164 and a rear wall 166 that may be curved to match the cross sectional shape of the leg structure 14 when the leg structure 14 is seated against the rear wall 166. The notch 160 further includes a mouth 168 that may be slightly narrower than the cross section of the leg structure 14 to encourage the leg structure 14 to seat against the rear wall 166 and to prevent the leg structure 14 from pulling out of the notch 160 after it has been inserted. The bottom wall 150 may include a hole 170, which may extend into the upper wall 162 of the notch 160, but in one embodiment does not extend entirely through upper wall 162 of the insert 16. As illustrated, the hole 170 is positioned in the center of the bottom wall 150. In one embodiment, the top wall 152 is contoured to match the contour of the lower surface 26 of the seat portion to enable the insert 16 to fit flush against the lower surface 26 of the seat portion 18. The four inserts for each seat may each have a uniform top wall 152, such that the same insert 16 can be attached to the seat portion 18 in four different locations; however, in one embodiment, each insert 16 may have a different shape to accommodate differences in the contour of the lower surface 26 of the seat portion 18.

As shown in FIGS. 1-3, in one embodiment, the seat inserts 16 are attached to the receptacles 28a-d in a manner that will enable the inserts 16 to receive the leg structure 14 shown in FIGS. 1-3. In this embodiment, the inserts 16 in the receptacles 28a and 28b are positioned with their notches 160 facing in the same direction, towards the receptacles 28c and 28d respectively. The inserts 16 in the receptacles 28c and 28d face towards the receptacles 28a and 28b respectively. The inserts 16 in the receptacles 28a and 28b are spaced apart to receive the cross piece 74 of the second support member 52 with the holes 86, 88 in the cross piece 74 aligned with the holes 170 in the respective inserts 16. The seat inserts 16 in the receptacles 28c and 28d are spaced apart to receive the cross piece 54 of the first support member 50 with the holes 66, 68 in the cross piece 54 aligned with the holes 170 in the respective inserts 16. In another embodiment, the inserts 16 may be attached to the receptacles 28a-d with the notches 160 facing in other directions not shown in the drawings, with pairs of inserts 16 having their notches aligned along a common axis such that the cross pieces 54, 74 can each be inserted into the notches 160 of two of the seat inserts 16. The inserts 16 may be attached to the receptacles 28a-d, or to another portion of the seat body 12 by any conventional method.

In one embodiment, the sidewall 30 of each receptacle 28a-d extends around an upper portion of the sidewall 154 of an insert 16 to retain the insert 16 in the receptacle 28a-d. The sidewall 30 may be molded about the sidewall 154 of the insert 16, for example, by placing the insert 16 into a mold and forming the seat body 12 in the mold with one of the receptacles 28a-d being molded about the insert 16. Alternatively, the seat inserts 16 may be attached to the seat body 12 by adhesive, sonic welding, one or more fasteners, or another conventional attachment method. When the cross pieces 54 and 74 are positioned within the notches 160, fasteners 200 may be inserted through the holes 66, 68, 86 and 88 respectively and into the cross pieces 54, 74 to attach the cross pieces 54, 74 to the inserts 16.

The configuration of the inserts 16 may be varied depending on the type of leg structure to be connected to the seat body 12. For instance, as shown in FIGS. 4-5, when attaching the leg structure 114 to the seat body 12, the inserts 16 may all be positioned to face in the same direction to enable insertion of the each of the side members 130, 132 into the notches 160 of two of the inserts 16. The inserts 16 are spaced apart such that the holes 170 in the inserts each align with one of the holes 136, 138, 140, 142 in one of the side members 130, 132.

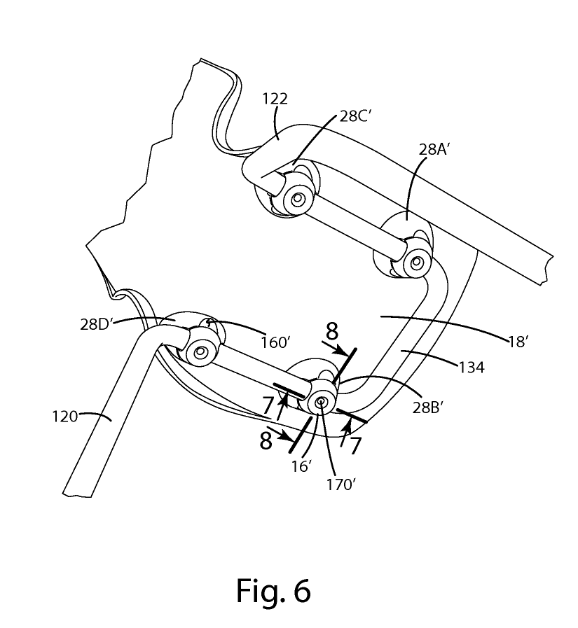

Another embodiment is shown in FIGS. 6-8. Some attributes of this embodiment may be configured similar to the other embodiments and will not be described here. In the illustrated embodiment, the receptacles 28a′-d′ define two notches 160′ substantially perpendicular to one another in their bottom surfaces for receiving the leg structure 14. This configuration allows the receptacles 28a′-d′ to receive the leg structure 14 in either notch 160′, which allows the leg structure 14 to be received in multiple orientations. For example, the leg structure 14 may be received in the orientation shown in FIG. 6, or may be received in three other orientations, each orientation obtained by rotating the leg structure 14 by 90°. Optionally, the receptacles 28a′-d′ may define more than two notches 160′, which would increase the number of possible orientations of leg structure 14.

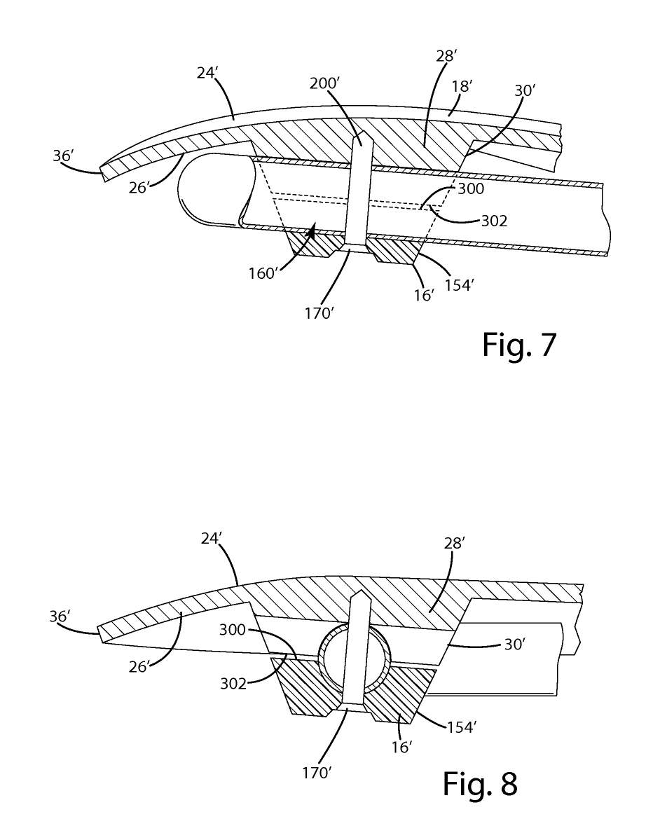

In this embodiment, the seat inserts 16′ are formed separately from the seat portion 18′ and are secured over the leg structure 14 to secure the leg structure 14 to the seat portion 18′. As with the other embodiments and as shown in FIGS. 7-8, the angle of the sidewall 154′ may match the angle of the sidewall 30′ of the receptacles 28a′-d′. The seat inserts 16′ may be secured using any method described in connection with the other embodiments.

As shown in FIGS. 7 and 8, the receptacle 28′ includes a bottom surface 302 and the seat insert 16′ includes a top surface 300. In the illustrated embodiment, the two surfaces 300, 302 are spaced from one another. In other embodiments, the two surfaces 300, 302 may engage or interface with one another. The seat inserts 16′ may be made of any material described in connection with the other embodiments and may be made using any manufacturing process described in connection with the other embodiments.

III. Manufacture

In one embodiment, the present invention is manufactured by the steps of: (a) forming the seat inserts 16, (b) forming the seat body 12, (c) forming the leg structure 14, (d) attaching the seat inserts 16 to the seat body and (e) attaching the leg structure 14 to the seat inserts 16.

The seat inserts 16 may be formed from a variety of conventional methods. In one embodiment, the seat inserts 16 are formed by injection molding. Similarly, the seat body 12 may be formed by any conventional method, and in one embodiment the seat body 12 is formed by injection molding the seat body 12 as a single piece of material, including the receptacles 28a-d on the lower surface 26 of the seat portion 18. In one embodiment, the seat inserts 16 are formed in a first mold, and then removed from the first mold and inserted into a second mold. The second mold may be shaped to form the seat body 12. The plastic is injected into the second mold such that it forms the receptacles 28a-d extending around the seat inserts 16, with one insert 16 positioned in each receptacle 28a-d and with the inserts 16 each facing in the desired direction with respect to the seat body 12. In another embodiment, the inserts 16 may be formed after the seat body 12, and attached to the seat body 12 by another method. For example, in the embodiment shown in FIGS. 6-8, the inserts 16′ may be separately attached to the seat portion 18 after the inserts 16′ are formed.

The leg structure 14 is attached to the seat inserts 16 by inserting each of the cross pieces 54, 74 into two of the notches 160 in the inserts 16. In one embodiment, the cross piece 54 is inserted into the notches 160 of the inserts 16 in the receptacles 28a-b and the cross piece 74 is inserted into the notches 160 of the inserts 16 in the receptacles 28c-d. The curved cross sectional shape of the notches 160, with a mouth 168 that is slightly narrower than the remaining portion of the notch 160 enables the cross pieces 54, 74 to snap fit into the notches 160 and prevents unwanted removal from the notches 160. After the cross pieces 54, 74 are inserted into the notches 160 of the seat inserts 16, fasteners 200 can be inserted into the holes 170 in each of the seat inserts 16 and through the holes 66, 68, 86, 88 in the cross pieces 54, 74 and into the holes in the upper wall 162 of each notch 160 to secure the cross pieces 54, 74 within the seat inserts 16. Similarly, the leg structure 114 may be secured to the inserts 16 by inserting the side members 130, 132 into notches 160 in the seat inserts 16 and inserting fasteners 200 through the holes 170 and into the holes 136, 138, 140, 142 in the side members. In the embodiment shown in FIGS. 6-8, the leg structure 14 may be inserted into one or more selected notches 160′ in a selected orientation. The seat inserts 16′ may be placed over the leg structure 14, aligned with a respective receptacle 28a′-d′, and secured by inserting one or more fasteners 200′ into holes 170′.

Directional terms, such as “vertical,” “horizontal,” “top,” “bottom,” “upper,” “lower,” “inner,” “inwardly,” “outer” and “outwardly,” are used to assist in describing the invention based on the orientation of the embodiments shown in the illustrations. The use of directional terms should not be interpreted to limit the invention to packages of any specific orientation(s).

The above description is that of current embodiments of the invention. Various alterations and changes can be made without departing from the spirit and broader aspects of the invention as defined in the appended claims, which are to be interpreted in accordance with the principles of patent law including the doctrine of equivalents. This disclosure is presented for illustrative purposes and should not be interpreted as an exhaustive description of all embodiments of the invention or to limit the scope of the claims to the specific elements illustrated or described in connection with these embodiments. For example, and without limitation, any individual element(s) of the described invention may be replaced by alternative elements that provide substantially similar functionality or otherwise provide adequate operation. This includes, for example, presently known alternative elements, such as those that might be currently known to one skilled in the art, and alternative elements that may be developed in the future, such as those that one skilled in the art might, upon development, recognize as an alternative. Further, the disclosed embodiments include a plurality of features that are described in concert and that might cooperatively provide a collection of benefits. The present invention is not limited to only those embodiments that include all of these features or that provide all of the stated benefits, except to the extent otherwise expressly set forth in the issued claims. Any reference to claim elements in the singular, for example, using the articles “a,” “an,” “the” or “said,” is not to be construed as limiting the element to the singular.

1. A chair construction comprising:
a seat body for supporting a person in a seated position, the seat body including a seat portion having an upper surface and a lower surface, the lower surface including at least one receptacle;
a leg support structure for supporting the seat body; and
a seat insert securing the leg support structure to each receptacle, the seat insert defining a notch sized to receive a portion of the leg support structure.

2. The chair construction of claim 1 wherein each receptacle is integral with the lower surface.

3. The chair construction of claim 1 wherein the seat insert has a lower wall, a lower notch wall and an upper notch wall,
wherein the seat insert defines a fastener hole for receiving a fastener, the fastener hole defined through the lower wall, through the lower notch wall and into the upper wall.

4. The chair construction of claim 3 wherein the seat insert has a cross-sectional diameter taken substantially parallel to the notch,
wherein the notch extends a distance into the seat insert, the distance equal to approximately ¾ of the cross-sectional diameter of the seat insert.

5. The chair construction of claim 3 wherein the notch has a central portion and a mouth,
wherein a notch height is defined between the upper notch wall and the lower notch wall,
wherein the notch height in the mouth is smaller than the notch height in the central portion to provide a snap fit connection with the leg support structure.

6. The chair construction of claim 1 wherein the seat insert includes a sidewall, the seat insert sidewall being frustoconical.

7. The chair construction of claim 1 wherein the seat insert defines more than one notch, each notch adapted to receive the portion of the leg support structure in a different orientation.

8. A seat insert for connecting a seat body and a leg support structure comprising:
a top wall adapted to interface with a lower surface of the seat body;
a bottom wall opposing the top wall;
a sidewall extending between the top wall and the bottom wall; and
a notch defined in at least one of the bottom wall and the sidewall for receiving a portion of the leg support structure.

9. The seat insert of claim 8 including a first notch wall and a second notch wall, a notch height being defined between the first notch wall and the second notch wall, the notch height varying along a length of the notch.

10. The seat insert of claim 9 wherein the notch has a central portion and a mouth,
wherein the notch height in the central portion is substantially equal to a height of the portion of the leg support structure.

11. The seat insert of claim 10 wherein the notch height in the mouth is less than the height of the portion of the leg support structure.

12. The seat insert of claim 11 wherein the notch defines a rear notch wall, the first notch wall, the rear notch wall and the second notch wall being contoured to substantially match a contour of the portion of the leg support structure.

13. The seat insert of claim 12 wherein a fastener hole is defined through the bottom wall, through the first notch wall, and into the second notch wall.

14. The seat insert of claim 8 including more than one notch defined in the bottom wall, each notch adapted to receive the portion of the leg support structure in a different orientation.

15. A method for manufacturing a seat construction comprising:
forming at least one seat insert, each seat insert defining a notch;
forming a seat body;
forming a leg support structure; and
attaching the leg support structure to the at least one seat insert, including fitting a portion of the leg support structure into each notch.

16. The method of claim 15 wherein the forming a seat body step includes inserting the at least one seat insert into a mold and molding the seat body to form a receptacle around each seat insert.

17. The method of claim 15 including attaching the at least one seat insert to the seat body.

18. The method of claim 15 wherein the fitting a portion of the leg support structure into each notch step includes snap fitting the portion of the leg support structure into each notch.

19. The method of claim 18 wherein the attaching the leg support structure step includes securing the portion of the leg support structure to each seat insert with a fastener that extends through a first portion of the seat insert, the leg support structure, and into a second portion of the seat insert that is spaced from the first portion.

20. The method of claim 15 wherein the forming at least one seat insert step includes injection molding the at least one seat insert.
